(19) United States
(12) Patent Application Publication
(10) Pub. No.: US 2010/0308593 A1
(43) Pub. Date: Dec. 9, 2010

(54) Method for Generating Rotation using Water Power

(76) Inventors: Alan John Mackinder, Yorkshire (GB); Janice Gibbon, Yorkshire (GB)

Correspondence Address: Alan;Mackinder, 1 Weelsby Way, Hessle, Kingston upon Hull, HU13 0JN, omitted

(21) Appl. No.: 12/780,922

(22) Filed: May 16, 2010

(30) Foreign Application Priority Data
Jun. 4, 2009 (GB) 0909547.2

(51) Int. Cl. F03B 13/00; F03G 3/04

(52) U.S. Cl. 290/54; 60/639

(57) ABSTRACT

A method for generating rotation from the interaction of water with curved surfaces utilises a rotating assembly with a configuration of objects with curved surfaces suspended from radial arms which are connected to a swing bearing. A continuous water supply fed to the curved surfaces of the suspended objects cause a horizontal force to be generated and this force causes the rotating assembly to rotate in a sustainable manner. This method can be used to construct low head hydro electricity generation systems or on a smaller scale water features, with rotational elements, for decorative purposes.

### CROSS-REFERENCE TO RELATED APPLICATIONS

This application has a priority date of 4 Jun. 2009 on the basis of an application to the UK Intellectual Property Office filed on the 4 Jun. 2009. The UK patent application number is 0909547.2

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to providing a method for hydro power generation from low head water sources and also a method using pumped water to deliver rotational effects in water features.

There has always been a need to manage renewable energy resources in the most efficient way, especially now, where it is vital to keep down the levels of carbon dioxide in the atmosphere, which in turn will help to mitigate the effect of climate change.

Equally water features deliver a visual amenity from which people derive pleasure and a feeling of wellbeing.

### BRIEF SUMMARY OF THE INVENTION

This invention discloses a method which will deliver rotating motion by the application of falling water onto objects with curved surfaces suspended from an assembly connected to a swing bearing via a fixed column. This rotating motion can be utilised for hydro power generation and the creation of a rotating effect in a decorative water feature.

### BRIEF DESCRIPTION OF SEVERAL VIEWS OF DRAWINGS

Illustrative sketches included under the heading DRAWINGS

All sketches are illustrative only, they are not to scale and are referred to in the specification as a means of describing the functionality of the method. They represent one instance of many potential instances for applying the method. Sketches are on pages 11 and 12 of this document.

FIG. 1 shows a plan and elevation view. The plan view is common to both the hydro power application and the water feature application.

The plan view denotes two spheres suspended from a rotating assembly and the discharge of water in a downward direction over opposing faces of the spheres with arrow (6) showing the resultant direction of rotation as a result of the water flow. The elevation view, which is specific to the hydro-power application, shows a source of water (10) for the hydro-power generation together with a means of supporting the rotating assembly and a means of delivering the water to the opposing faces of the spheres. It also shows how a power generation package might be mounted on the supporting column for the rotating assembly

FIG. 2 shows an elevation view which is specific to the water feature application. The supply of water is recycled and there is no power generation package

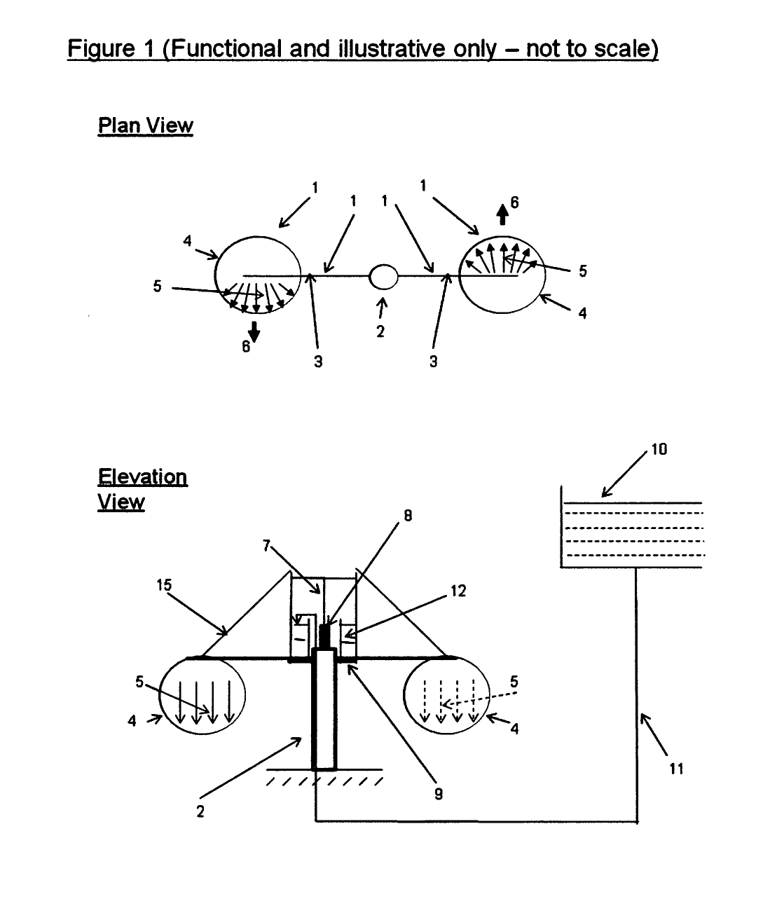

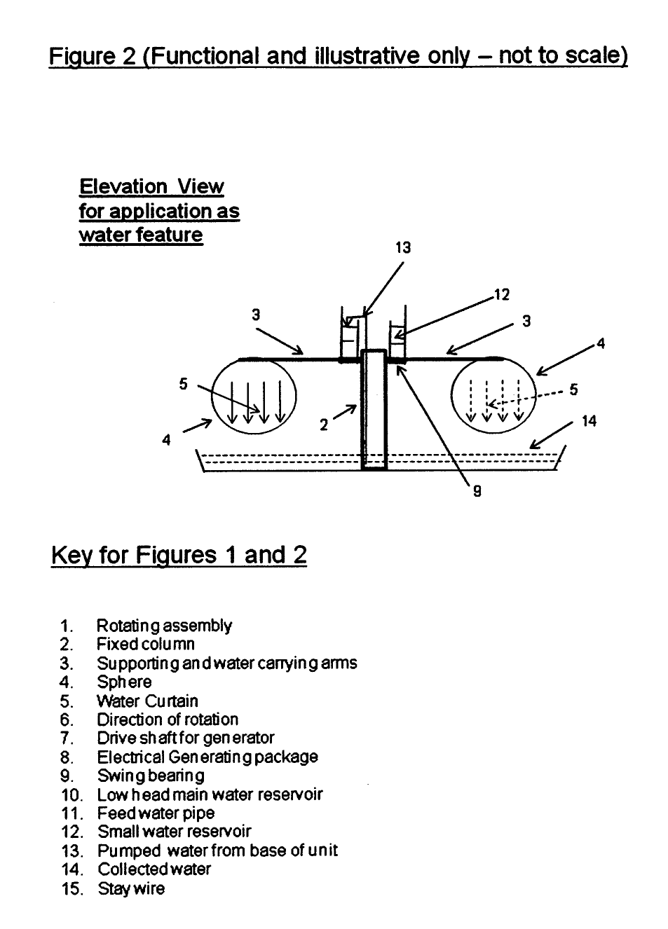

The Key for FIGS. 1 and 2 is located on the same page as FIG. 2.

### DETAILED DESCRIPTION OF THE INVENTION

### Hydro-Power Application:

Water turbines, presently in use, rely on a significant head of water to impinge on turbine blades connected to a shaft to create rotational movement of the shaft, within an enclosure to control the flow of water, to deliver power generation. With very low heads of water the water turbine does not deliver an effective power output.

The following invention discloses a method to generate hydro power from low water head sources.

The basis for the method is that when water falls on a suspended curved surface a horizontal force is generated by the action of the water moving across the curved surface.

This is a well known phenomenon called the ‘Coanda Effect’, which can be demonstrated by loosely holding the curved surface of a spoon under a tap with a running stream of water. When the curved surface of the spoon is in contact with the water stream it is drawn into the stream by a resultant horizontal force. This force is analogous to the force of lift on the wing of an aircraft caused by air movement over curved surfaces of the wings of aeroplanes.

The energy associated with a high flow of water with a low hydrostatic head is harnessed by creating a rotating assembly in the horizontal plane with arms on a fixed column to hold suspended objects with curved surfaces. The action of water falling on these objects with curved surfaces generates resultant horizontal forces at the curved surfaces to deliver rotational motion to the assembly in the horizontal plane. A sphere has a large curved surface area to generate these horizontal forces that act on the rotating assembly and has been chosen as the object shape to demonstrate the method.

The method covers any configuration of curved objects, from single to multi objects, associated with a rotating assembly but for illustrative purposes FIG. 1 shows the plan and elevation views of two spheres attached, via arms, to a swing bearing on the top of a fixed column.

The configuration of the connection of the rotating assembly to the fixed column is similar to that used for marine pedestal cranes in this illustration but other configurations could be applied to deliver the rotational motion depending on circumstance.

The supporting arms also serve to carry a supply of water from the hydro source to the spheres, delivering water to continuously discharge over one half of the spheres as shown in FIG. 1. There will be a number of ways of delivering the water supply to the curved objects within the rotating assembly, so the means of getting water to the spheres is not viewed to be a fundamental element of the invention. For illustrative purposes a small water reservoir, sited on the bearing at the top of the fixed column, has been chosen as the delivery method, via the support arms, for getting water from the main water reservoir to the spheres.

When a supply of water is directed downwards onto one half of each of the spheres, as shown in FIG. 1, rotation occurs in the direction shown on the plan view of FIG. 1. The continuous delivery of water sustains the rotation.

A power generation package sits on top of the fixed column to convert the resultant rotational energy into electrical energy for transmission, via cable, to an electric power system.

Mechanical stability for the assembly is achieved with the use of stay wires as shown in FIG. 1.

Various sizes of units can be created using the principles described above in a variety of configurations of curved surfaces and rotating assemblies

The unit sizes will depend on the sustained flow rate from a water source that is available to deliver sustainable rotation to the chosen configuration of rotating assembly.

### Water Feature Application:

On a smaller scale a water feature can be created using a pump and recycled water. Here the water would be pumped to the rotating assembly from a water supply contained within the water feature. The principles of operation would be the same as for the larger units but the water would be collected and reused.

### Specific Embodiment

A specific embodiment of the invention, covering both of these applications, will now be described by way of example:

Water from a low head reservoir is fed via a feed pipe with means of flow control to a small water reservoir attached to the swing bearing on top of the fixed column. This small water reservoir is sized to give sufficient buffer water capacity to deliver an uninterrupted flow of water, along the supporting arms, to half of the curved surface of each sphere.

Each of the connecting supporting arms attached to the spheres is constructed to deliver a water supply to discharge over half of the surface areas of each sphere, as shown in FIG. 1.

When the water falls onto opposing halves of each sphere to produce a water flow over the respective surface areas, a horizontal force is created that causes the rotating assembly to rotate. The plan view in FIG. 1 shows the positions that the water flows are applied and the resultant direction of rotation of the rotating assembly.

A flow control valve in the feed line is set at the optimum flow rate to give continuous steady rotation.

Electrical energy is collected from the assembly using a vertical drive shaft, as shown in FIG. 1 elevation view, connected to a power generation package installed at the top of the fixed column. The generated electrical energy is then transmitted, via a cable, as shown in FIG. 1, for utilisation in an electricity system.

FIG. 2 illustrates how the elevation view in FIG. 1 would change to accommodate the application of the method to a water feature. The plan view would still be as in FIG. 1.

Incorporating this type of rotational element into water features will enhance the visual amenity of water features giving an additional dimension of enjoyment to water feature owners.

1. A method, utilizing an assembly of one or more curved object(s) suspended from a supporting means which allows the assembly to freely rotate about a vertical axis and a further means of supplying falling water over convex faces of the curved object(s) facing a first rotational direction, to generate a force in the first direction, and not supplying sufficient water to the oppositely facing surfaces of the curved object(s) to generate a significant force in the first direction thereby, thus causing the assembly to rotate in the first direction.

2. A method as described in claim 1 whereby the source of water is sufficient to allow hydro electricity generation from the head of water available.

3. A method as described in claim 1 whereby water is pumped and recycled to create a rotational effect in a water feature.
